(19) United States
(12) Patent Application Publication
(10) Pub. No.: US 2012/0246866 A1
(43) Pub. Date: Oct. 4, 2012

(54) Support System Adjustable by Like Motion and Method of Use

(75) Inventor: Stuart V. Holsten, Stover, MO (US)

(73) Assignee: EMERSON ELECTRIC CO., St. Louis, MO (US)

(21) Appl. No.: 13/073,129

(22) Filed: Mar. 28, 2011

(51) Int. Cl. A47L 9/02; F16M 13/02; F16M 13/00

(52) U.S. Cl. 15/415.1; 248/286.1; 414/800

(57) ABSTRACT

A support system may include a holder having a peripheral surface and a slot, a mount having a stop boss adapted to communicate with the peripheral surface, and a shaft coupled with the mount and slot, thereby slideably and rotatably coupling the holder and mount. A method of moving an object coupled to a support system may include supporting the object in a first position by disposing the mount at a start point of a path so that a center of gravity of the holder can be disposed at a first location relative to a pivot, moving the mount toward an end point of the path, which can include allowing the holder to rotate about the pivot, disposing the mount at the end point, and supporting the object in a second position.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The invention disclosed and taught herein relates generally to systems for supporting objects; and more specifically relates to adjustable support systems that engage and disengage using similar actuator inputs.

2. Description of the Related Art

Typically, mechanism actuators are moved one way to engage, and another way to disengage a mechanism being acted upon. Take, for example, the latch on the lid of a plastic storage box or tool box: to open the lid, the latch may move one way to release the latch so that the lid can be removed or opened. Conversely, to secure the lid back in a closed position, the latch will probably need to be moved the opposite direction. The same principles may also be illustrated with reference to a spring-loaded ratchet device. One such example is a common “come-a-long” hand winch. As one pulls on the lever to crank the cable, a spring loaded catch snaps against notches to keep the cable from unwinding. To release the cable, one would employ a second action of moving the catch away from the notches. As another example, consider a typical household deadbolt door lock. A key or handle may be turned one direction to lock the deadbolt and the opposite direction to unlock the deadbolt. However, in one or more applications, it will be advantageous to use a mechanism actuator that can be activated and deactivated using similar, or the same, inputs or motions. Although the present invention can be used in numerous applications, it will be disclosed in one of many applications for illustrative purposes.

A vacuum appliance, such as a wet/dry or work area vacuum cleaner, may have a vacuum tool mounted on the vacuum body, such as for scrubbing or otherwise cleaning one or more surfaces during vacuuming. For example, a vacuum appliance may have a squeegee, brush, blade, or other tool mounted on the front of the unit. Attached to the tool may be a hose that couples to the inlet of the vacuum cleaner drum such that suction air and vacuumed debris flow from the tool through the hose and into the drum. In many applications, the tool may be adjustably mounted to the vacuum cleaner so that the tool can be selectively applied to a vacuum surface when desired and removed from the surface when not in use. For example, the tool may be lifted from the surface and supported in an “up” position when not in use, and may be released to a “down” position during vacuuming so that the tool can contact the surface being vacuumed. Therefore, it can be seen that it would be advantageous for a support system to hold, dispose or otherwise support the tool in two or more positions and allow a user to switch the tool between those positions using simple and similar user input actions.

The invention disclosed and taught herein is directed to an improved support system that engages and disengages using similar actuator motions and a minimal number of parts.

### BRIEF SUMMARY OF THE INVENTION

A support system may include a holder having a first face, a second face, at least one peripheral surface, and a slot extending from the first face at least partially through the holder toward the second face, a mount having an outer surface and at least one stop boss extending outwardly from the outer surface and adapted to communicate with the at least one peripheral surface of the holder, and a shaft having a first end coupled to the mount and a shaft body extending outwardly from the outer surface of the mount, wherein the shaft body can be slideably disposed in the slot, thereby coupling the holder to the mount so that the holder can rotate and slide relative to the mount about the shaft.

A method of moving an object between a first position and a second position, the object being coupled to a support system having a mount configured to move along a predetermined path and a holder slideably and rotatably coupled to the mount, may include supporting the object in the first position by disposing the mount at a start point of the path so that a center of gravity of the holder can be disposed at a first location relative to a pivot, moving the mount along the path toward an end point of the path, which can include allowing the holder to rotate about the pivot in a first direction, disposing the mount at the end point of the path, and supporting the object in the second position.

A support system may include a holder having an inner face, an outer face, three peripheral surfaces, and a slot extending from the inner face at least partially through the holder toward the outer face, a mount having a flat face, a rotation stop boss and an over-travel stop boss, each stop boss being coupled to the mount and extending outwardly from the flat face, a shaft having a first end coupled to the mount and a shaft body extending outwardly from the flat face, and wherein the shaft body is slideably disposed in the slot and the inner face of the holder is adjacent the flat face of the mount, thereby coupling the holder to the mount so that the holder can rotate and slide relative to the mount about the shaft.

A method of moving an object between a first position and a second position may include contacting a shoulder with the rest surface and contacting the rotation stop boss with the stop surface, thereby supporting the object in the first position and disposing the mount at a start point of a predetermined path of movement, moving the mount along the path toward an end point of the path, thereby allowing the holder to rotate about the shaft in a first direction, contacting the shoulder with the rubbing surface, disposing the mount at the end point of the path, and supporting the object in the second position. The holder may have a center of gravity having a location distal from the shaft when the mount is at the start point and the holder may rotate in the first direction due to the location of the center of gravity.

The method may include moving the mount along the path toward the start point, allowing the holder to rotate about the shaft in a second direction opposite the first direction, contacting the rotation stop boss with the stop face, contacting the shoulder with the rest face, disposing the mount at the start point; and supporting the object in the first position. The holder may have a center of gravity having a first location distal from the shaft when the mount is at the start point and the holder may rotate in the first direction due to the first location. The center of gravity may have a second location distal from the shaft when the mount is at the end point and the holder may rotate in the second direction due to the second location.

A tool assembly for a vacuum cleaner may include a frame configured to be moveably coupled to the vacuum cleaner, the frame having a first end and a second end, a tool coupled to the second end, and at least one support system coupled to the frame.

A vacuum cleaner system may include a vacuum body having a debris collector, an air inlet, and an air outlet, an electric vacuum motor coupled to the air outlet, a tool assembly coupled to the vacuum body, and a conduit having a first end coupled to the tool and a second end coupled to the air inlet, the conduit being adapted to carry air and debris to the debris collector during vacuuming.

A method of vacuuming a floor surface with a vacuum cleaner system having a shoulder coupled to the vacuum body adjacent to the holder and configured to communicate with at least one of the three peripheral surfaces, the three peripheral surfaces including a rest surface, a stop surface and a rubbing surface, the method including positioning the vacuum cleaner system on the floor surface with the tool in a first position distal from the surface, the mount being at a start point of a predetermined path of movement, the shoulder being in contact with the rest surface, and the rotation stop boss being in contact with the stop surface, moving the mount along the path toward an end point of the path using a first user action, allowing the holder to rotate about the shaft in a first direction, contacting the shoulder with the rubbing surface, disposing the mount at the end point, thereby disposing the tool in a second position in contact with the floor surface, and vacuuming the surface. The method may include applying or releasing a force about the frame and pivoting the frame about a pivot. The method may include moving the mount along the path toward the start point using a second user action, allowing the holder to rotate about the shaft in a second direction opposite the first direction, contacting the rotation stop boss with the stop face, contacting the shoulder with the rest face, and disposing the mount at the start point, thereby disposing the tool in the first position. The first and second user actions may, but need not, be at least partially similar or the same.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates an isometric view of one of many embodiments of a support system utilizing certain aspects of the present invention.

FIG. 2 illustrates an isometric assembly view of the embodiment of FIG. 1.

FIG. 3 illustrates an isometric view of the mount of FIGS. 1-2.

FIG. 4 illustrates an isometric view of the holder of FIGS. 1-2 having a biasing device.

FIG. 5A illustrates a schematic view of one of the biasing devices of FIG. 4.

FIG. 5B illustrates a schematic view of another of many embodiments of a biasing device utilizing certain aspects of the present invention.

FIG. 6 illustrates a top view of one of many embodiments of a support system supporting an object and utilizing certain aspects of the present invention.

FIG. 7 illustrates a side view of one of many embodiments of a support system in a first position and utilizing certain aspects of the present invention.

FIGS. 8-10 are stepwise views of the support system of FIG. 7 transitioning from the first position to a second position.

FIG. 11A illustrates a side view of the support system of FIG. 7 in a second position.

FIG. 11B illustrates a side view of one of many embodiments of a support system contacting a support surface in a second position.

FIGS. 12-13 are stepwise illustrations of the support system of FIG. 7 transitioning from the second position to the first position.

FIG. 14A illustrates a schematic illustration of one of many embodiments of a support system coupled with a support assembly in a first position and utilizing certain aspects of the present invention.

FIG. 14B illustrates a schematic illustration of the embodiment of FIG. 14A in a second position.

FIG. 15A illustrates a schematic illustration of another of many embodiments of a support system coupled with a support assembly in a first position and utilizing certain aspects of the present invention.

FIG. 15B illustrates a schematic illustration of the embodiment of FIG. 15A in a second position.

FIG. 16 illustrates an isometric view of one of many embodiments of a support system coupled to a tool assembly and utilizing certain aspects of the present invention.

FIG. 17 illustrates a top view of one of many embodiments of a support system coupled to a vacuum cleaner system and utilizing certain aspects of the present invention.

FIG. 18 illustrates a side view of the support system of FIG. 17 in a first position.

FIG. 19 illustrates a side view of the support system of FIG. 17 in an interim position.

FIG. 20 illustrates a side view of the support system of FIG. 17 in a second position.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION OF THE INVENTION

The Figures described above and the written description of specific structures and functions below are not presented to limit the scope of what Applicant has invented or the scope of the appended claims. Rather, the Figures and written description are provided to teach any person skilled in the art to make and use the invention for which patent protection is sought. Those skilled in the art will appreciate that not all features of a commercial embodiment of the invention are described or shown for the sake of clarity and understanding. Persons of skill in this art will also appreciate that the development of an actual commercial embodiment incorporating aspects of the present invention will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the invention disclosed and taught herein is susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally.

Applicant has created a system for supporting one or more objects in one or more positions, and for moving the one or more objects between the positions, such as at the option or input of a user. The support system may include a first component for coupling to an object to be supported, which may include structure for coupling to an actuator. The system may include a second component moveably coupled to the first component. The second component may comprise structure for communicating with one or more parts of the first component, and may further comprise structure for communicating with an adjacent body, such as a shoulder. The second component may be configured to rotate and slide relative to the first component as the system moves along a predetermined path between a first end point and a second end point on the path. The second component may be configured to dispose or otherwise support one or more objects in a first position when the system is disposed at the first end point and to support the object(s) in a second position when the system is disposed at the second end point. While the support system has many applications, the system is described herein with respect to a vacuum cleaner tool application for illustrative purposes. It should be noted that the term “support” and iterations thereof are used broadly herein and specifically include, without limitation, holding, affecting, sustaining, disposing, communicating with, or otherwise being related to. As used herein, support may include being coupled to or bearing the weight of, in any manner or degree, but need not, and may alternatively include positioning, uncoupling, releasing, or other types of support required by a particular application.

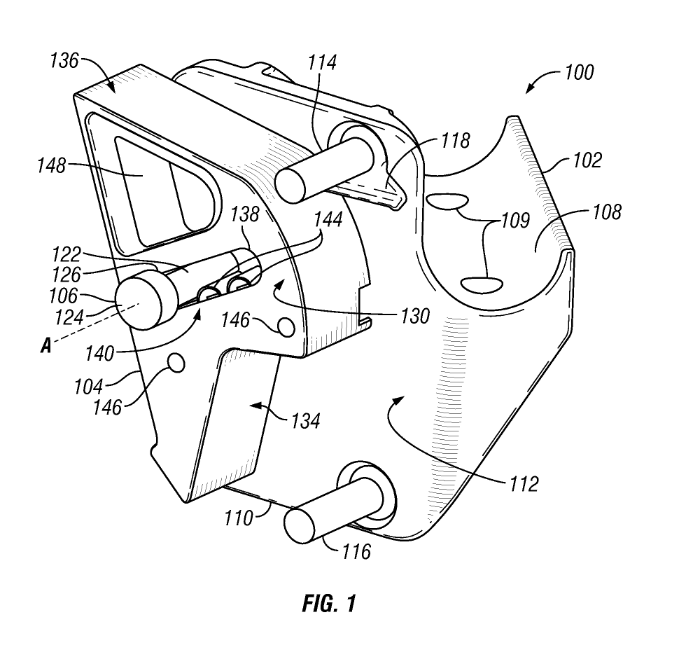

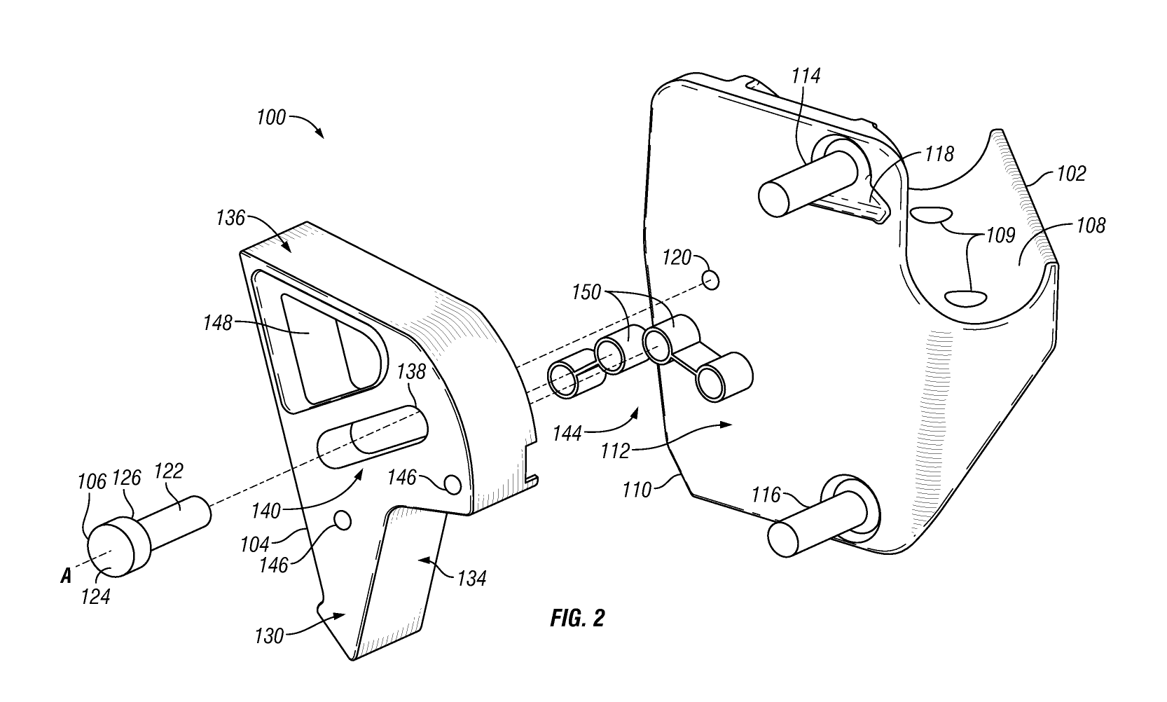

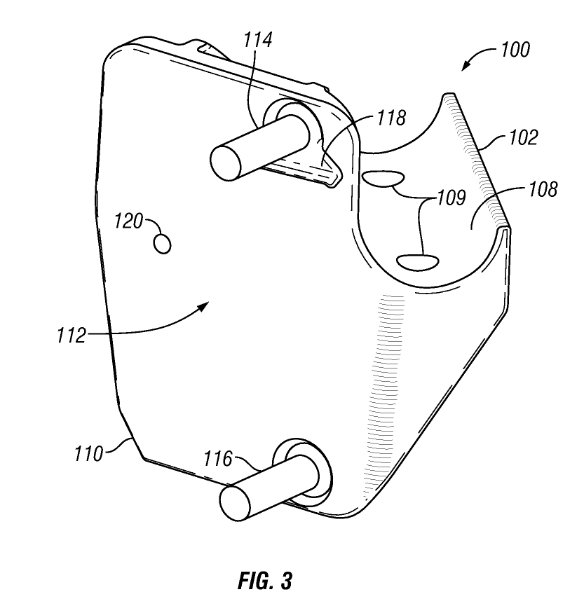

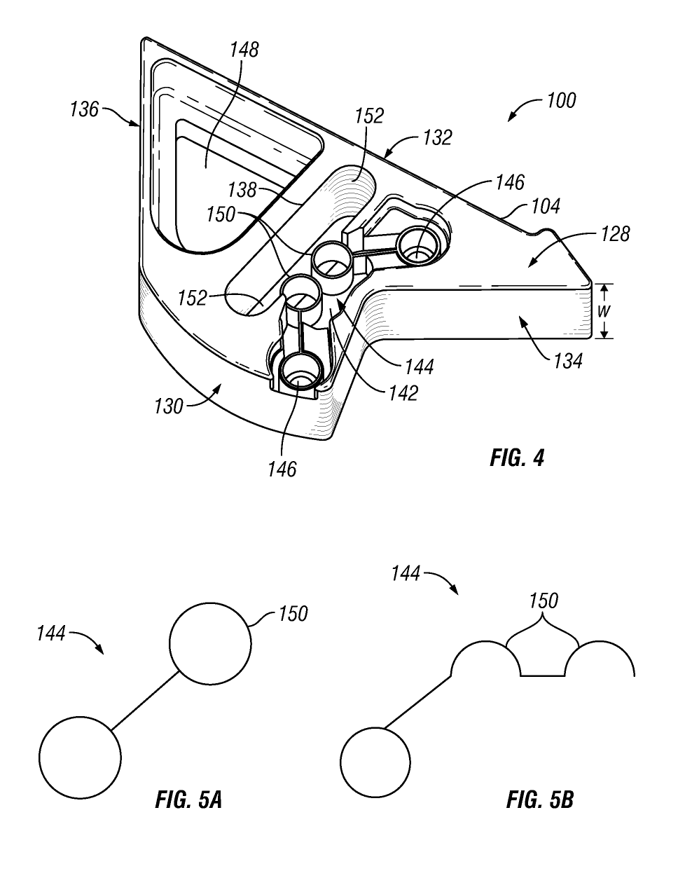

FIG. 1 is an isometric view of one of many embodiments of a support system 100 utilizing certain aspects of the present invention. FIG. 2 is an isometric assembly view of the embodiment of FIG. 1. FIG. 3 is an isometric view of the mount 102 of FIGS. 1-2. FIG. 4 is an isometric view of the holder 104 of FIGS. 1-2 having a biasing device 144. FIG. 5A is a schematic view of one of the biasing devices 144 of FIG. 4. FIG. 5B is a schematic view of another of many embodiments of a biasing device 144 utilizing certain aspects of the present invention. FIGS. 1-5B will be described in conjunction with one another. Support system 100 may generally include a base or mounting bracket, such as mount 102. System 100 may also include a holder 104, such as a support or bracket, moveably coupled to mount 102, and a shaft 106, such as a bolt, shoulder bolt or other shaft, for coupling mount 102 and holder 104 together. These components, and the components thereof, may be formed in any manner, such as integrally or separately, and from any material required by a particular application, such as plastic, metal, composite, or another material, separately or in combination. Mount 102 may have a first portion 108 for coupling to an object to be held or otherwise supported by support system 100 and a second portion 110 for communicating with holder 104. First and second portions 108, 110 may be formed integrally with one another, or formed separately and coupled together, in whole or in part. As shown in FIGS. 1-3 for illustrative purposes, and without limitation, first portion 108 is configured to couple to an object to be supported, such as a rounded bar or tube, as will be further described below. However, this need not be the case and, alternatively, first portion 108 may be formed or adapted to couple to any object required by a particular application, in any manner, for example, using fasteners, straps, welding or other methods of coupling, which may, but need not, include one or more fastener receptacles 109, such as holes, as will be understood by one of ordinary skill in the art. Second portion 110 may be configured for coupling to and/or communicating with holder 104, as further described below. Second portion 110 may include a face 112, such as an at least partially flat face, which may preferably be oriented vertically, or substantially vertically, during operation of support system 100. Alternatively, face 112 may be oriented other than vertically, depending on factors such as weights of components, friction, geometrical relationships of components, or other factors, as will be understood by one of ordinary skill having the benefits of this disclosure. Second portion 110 may include one or more travel limiters or stops, such as rotation stop boss 114 and over-travel stop boss 116, for communicating with one or more portions or surfaces of holder 104, as further described below. Each stop boss 114, 116 may, but need not, include one or more supports 118, such as a brace or flange, and may be coupled to mount 102 in any conventional manner. Mount 102 may, but need not, include a shaft coupler 120 (see FIG. 3) for coupling with shaft 106. For example, in at least one of many embodiments, and without limitation, shaft 106 may be a bolt or screw, and coupler 120 may include a threaded hole for coupling there with. However, this need not be the case and, as another example, coupler 120 may be a smooth hole, or absent, and shaft 120 may be coupled to mount 102, such as to face 112, for example by welding, force fit, integral formation, or another method of coupling. Shaft 106 may have a body 122, which may, but need not, be smooth, and a head 124, which may include a bottom face, such as shoulder 126, for communicating with holder 104. Shaft 106 may include a central longitudinal axis A, such as an axis about which holder 104 may rotate during operation, as will be further described below.

With reference to FIGS. 1, 2 and 4, holder 104 may include an inner face 128, an outer face 130, and a plurality of peripheral surfaces for communicating with one or more other components of support system 100. Inner face 128 may be configured to communicate with face 112 of mount 102, and may preferably be at least partially flat, for example, for rotating and sliding relative to mount 102. As illustrated in the embodiment shown in FIGS. 1 and 4, which is but one of many, the plurality of peripheral surfaces may include a rubbing surface 132, a rest surface 134, and a stop surface 136. Holder 104 may include a slot 138, which may, but need not, be a through slot, for receiving at least a portion of shaft 106. Outer face 130 may have any shape or contour required by a particular application. For example, as shown in the exemplary embodiment of FIGS. 1 and 2 for illustrative purposes, face 130 may preferably be at least partially flat, such as having a flat portion 140, such as a slide surface, adjacent or proximate the periphery of slot 138 for communicating with shoulder 126, such as to support a mounting association between holder 104 and mount 102. Shaft body 122 may, but need not, be longer than the width “w” (see FIG. 4) of holder 104 or may be otherwise configured, for example, so that holder 102 may be free to rotate and slide within slot 138 about shaft 106. For example, holder 104 may slide or rub against shoulder 126 on one side (i.e., outer face 130) and face 112 of mount 104 on the other side (i.e., inner face 128). Holder 104 may, but need not, include a void, such as cutout 148, which may be partial or through, if present. Cutout 148 may be any shape or size and may, for example, reduce or otherwise alter one or more characteristics of support system 100, such as mass or the location of a center of gravity (CG), as will be further described below. Inner face 128 of holder 104 may include a recessed area 142, for example, for coupling a biasing device 144, which may comprise one or more springs, therein, in whole or in part. As will be understood by one of ordinary skill in the art, biasing device 144 may be coupled to holder 104 in any manner required by a particular application, which may, but need not, include use of one or more fasteners (not shown), for example, fasteners that may communicate with holes 146, such as threaded holes, which may, but need not, be present. With additional reference to FIGS. 5A and 5B, biasing device 144 may include one (e.g., FIG. 5B) or more devices, separately or in combination. As shown in FIGS. 4 and 5A for illustrative purposes, biasing device 144 may include one or more springs, such as springs made of formed flat spring steel. In such an embodiment, which is but one of many, at least a portion of biasing device 144, such as one end 150, may protrude at least partially into slot 138, for example, to at least temporarily confine shaft 106 to a particular area of slot 138, such as to one of the end sections 152, during operation of support system 100, as will be further described below. In at least one preferred embodiment, which is but one of many, biasing device 144 may be stiff enough to at least partially withstand or counteract the weight of holder 104, but may flex out of the way of shaft 106 when a sufficient force is applied to biasing device 144, such as a force greater than that due to the weight of the holder, or any other force required by a particular application. When biasing device 144 is flexed sufficiently out of a path defined by slot 138, shaft 106 may pass by biasing device 144, which may allow holder 104 to move relative to shaft 106, such as to allow the position of shaft 106 to move from one end 152 of slot 138 to the opposite end 152. The advantages of this feature of the present invention will be explained in further detail below. While biasing device 144 has been illustrated as described above, it will be understood by one of ordinary skill having the benefits of this disclosure that biasing device 144 may be any type of biasing device or mechanism, and may be formed in any manner required by a particular application. For example, biasing device 144 may include one or more tension springs or compression springs, separately or in combination, or as another example, may include no spring at all.

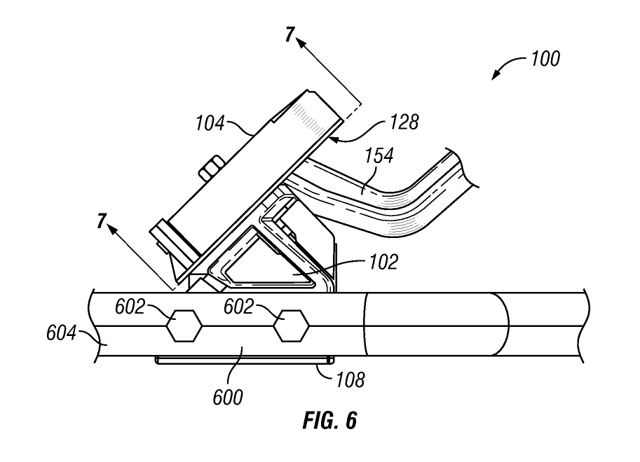

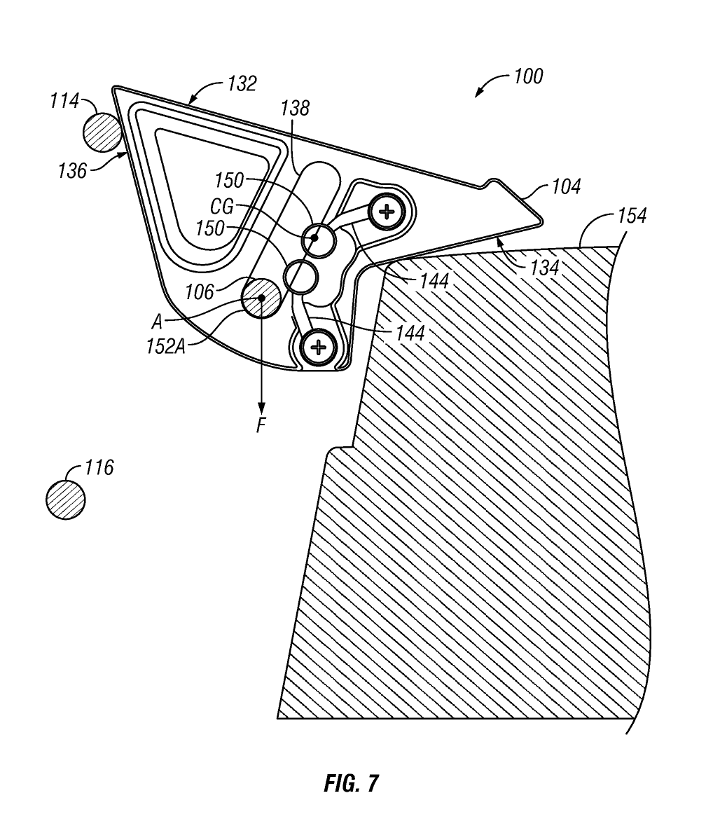

FIG. 6 is a top view of one of many embodiments of a support system 100 supporting an object 600 and utilizing certain aspects of the present invention. Support system 100 may include a stop, such as shoulder 154, coupled adjacent to holder 104, for example, so that at least a portion of holder 104, such as one or more peripheral surfaces, may selectively communicate with shoulder 154. Shoulder 154 may be any structure or device capable of supporting one or more other components of support system 100, and specifically may include, without limitation, a stop boss, knob, shaft, bracket, base, edge, corner or other structure or surface capable of supporting holder 104. Shoulder 154 may, but need not, be rounded or curved, and may alternatively include a corner, such as a corner that is at least substantially 90°. In at least one embodiment, which is but one of many, and which will be further described below, shoulder 154 may be at least a portion of a caster foot. Support system 100 may support an object 600, which may be coupled to mount 102, such as to first portion 108. While object 600 is shown to be a shaft or tube in FIG. 6 for illustrative purposes, it will be understood that this need not be the case and that object 600 may include any object or number of objects required by a particular application. Object 600 may be coupled to mount 102 in an manner required by a particular application, which may, but need not include the use of fasteners, such as one or more bolts 602. Support system 100 may support object 600 in one or more positions and may function to move the object between positions. Object 600 may include an actuator 604 (further described below), but need not. Actuator 604 may alternatively be a structure separate from object 600 and otherwise coupled with support system 100, such as to mount 102. One of many examples of the operation of support system 100 will now be described in detail with reference to a series of figures as viewed through section line VII-VII taken along inner face 128 of holder 104 with mount 102 and object 600 omitted for point of clarity.

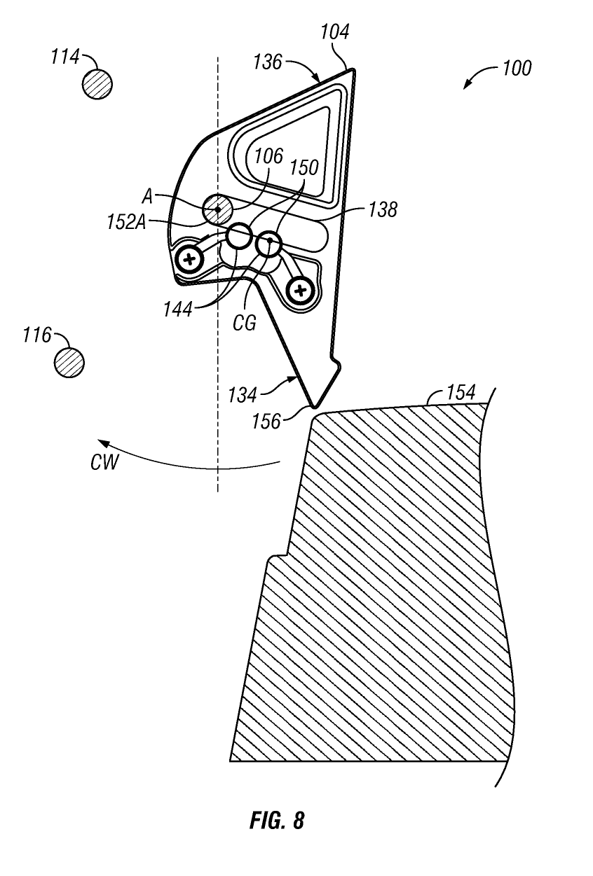

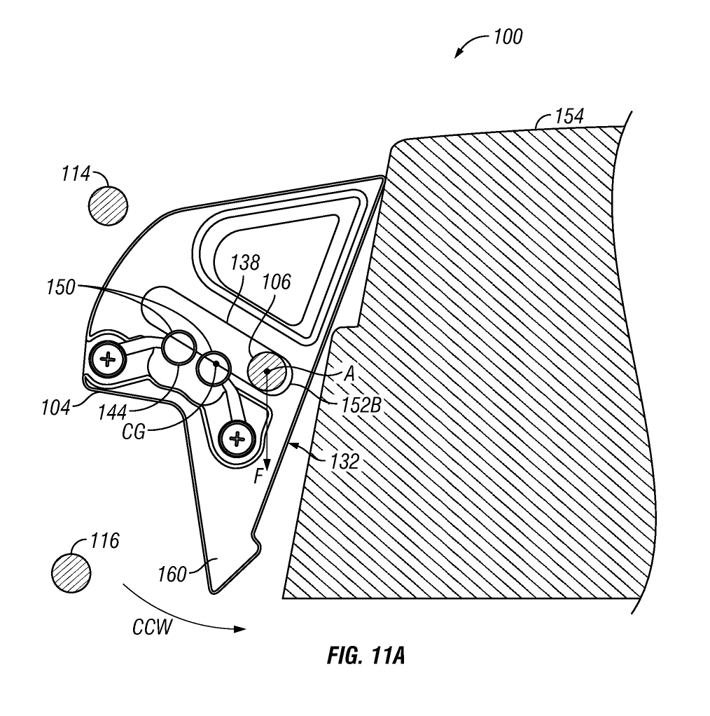

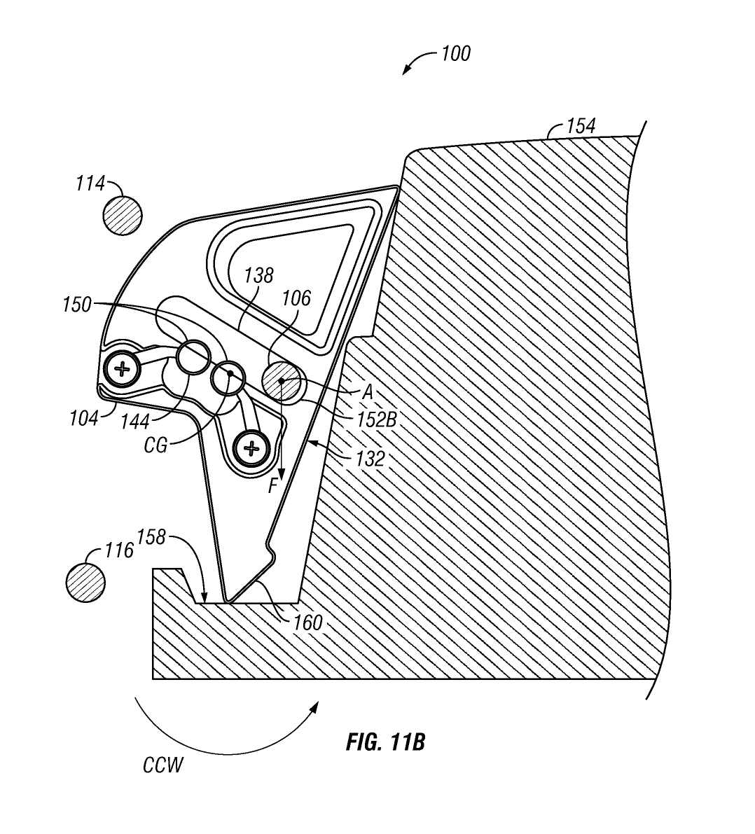

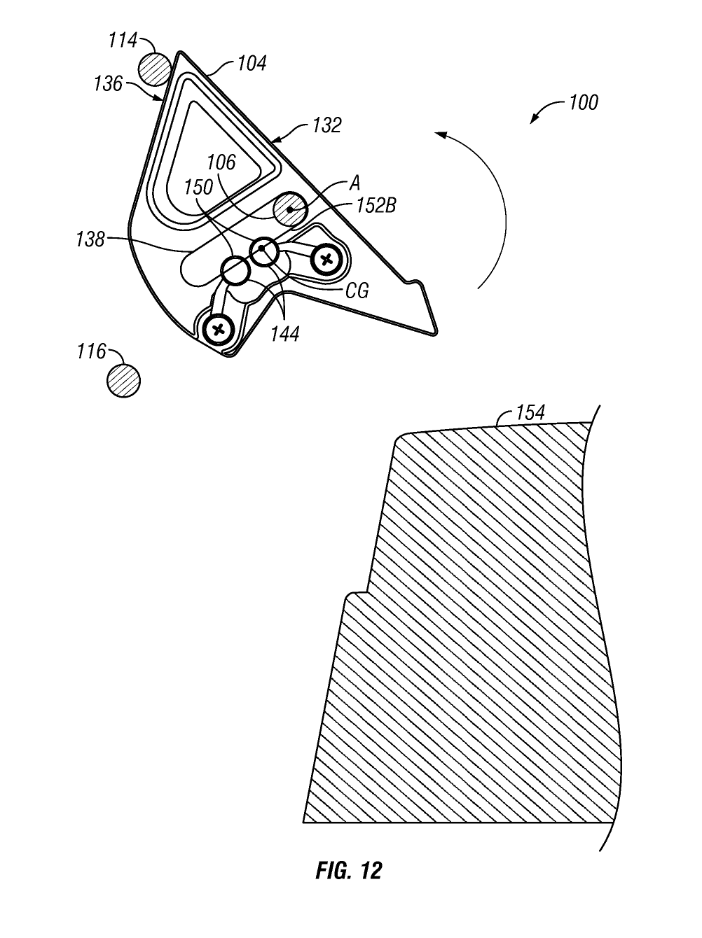

FIG. 7 is a side view of one of many embodiments of support system 100 in a first position and utilizing certain aspects of the present invention. FIGS. 8-10 are stepwise views of the support system 100 of FIG. 7 transitioning from the first position to a second position. FIG. 11A is a side view of the support system 100 of FIG. 7 in a second position and FIG. 11B is a side view of one of many embodiments of a support system 100 contacting a support surface 158 in a second position (collectively referred to herein as FIG. 11 unless otherwise indicated). FIGS. 12-13 are stepwise illustrations of the support system 100 of FIG. 7 transitioning from the second position to the first position. FIGS. 7-13 will be described in conjunction with one another. Support system 100 may support an object in one or more positions, either statically or dynamically, which may include any position required by a particular application. By way of example, FIGS. 7 and 11 show support system 100 in first and second static positions, respectively, wherein support system 100 may support an object in first and second positions, such as in up and down positions, deactivated and activated positions, disengaged and engaged positions, or other positions, in any order or number, separately or in combination. FIGS. 8-10 and 12-13 show several of many dynamic positions in which an object may be supported by support system 100, and show for illustrative purposes some of the many positions support system 100 may take during operation, as will be understood by one of ordinary skill. The positions and position numbers (e.g., 1 and 2) described herein are for purposes of reference and point of clarity, and do not imply any necessary order or otherwise limit the configurations or positions support system 100 may take, whether or not specifically described herein.

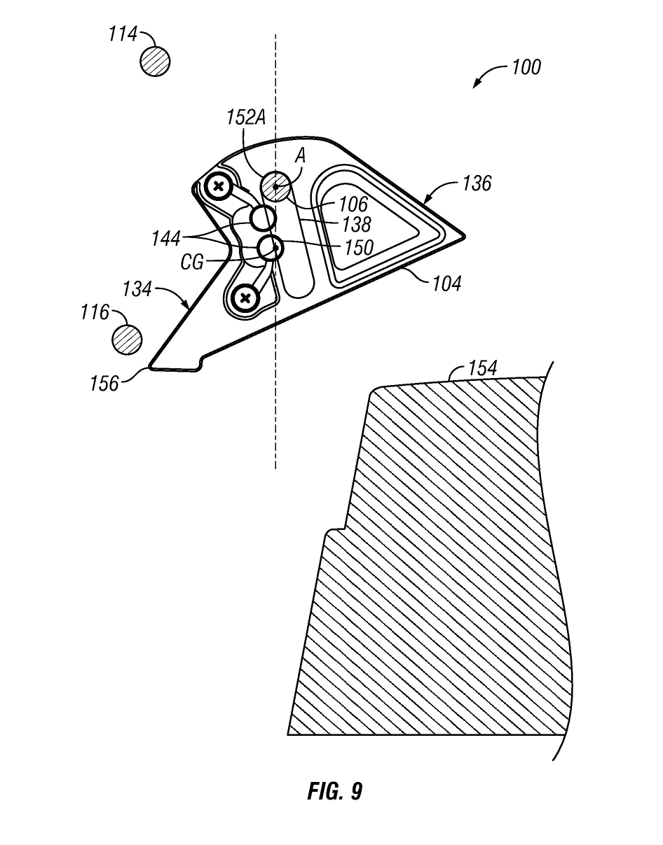

With reference to FIG. 7, support system 100 may include a first position (“Position 1”) for supporting an object in one of many positions required by a particular application. In Position 1, a downward force F may act on holder 104, for example, through shaft 106, such as due to the transfer of weight of mount 102 (not shown) and any object coupled thereto. Force F may cause shaft 106, having longitudinal central axis A, to rest at the bottom of slot 138, such as in section 152A, while rest surface 134 may rest against shoulder 154. Stop surface 136 may rest against rotation stop boss 114, which may restrain holder 104 from rotating away from shoulder 154. The CG of holder 104 may be located horizontally from axis A (e.g., to the right as shown in FIG. 7), which may tend to cause holder 104 to rotate about axis A (e.g., in the clockwise direction as shown in FIG. 7) over an angular distance, which can be any distance or degree, were holder 104 not supported by shoulder 154, for example, by contact between shoulder 154 and rest surface 134. In Position 1, an object may be supported in a first position and protruding end 150 of biasing device 144 may extend into a portion of slot 138 interior of shaft 106 or section 152A. From Position 1, support system 100 may be manipulated, such as by a first user action or input, to move through one or more interim positions to a second static position, referred to herein as Position 2 (FIG. 11), wherein support system 100 may move and support an object in a second position required by a particular application. For example, with reference to FIG. 8, support system 100 may be moved upward, such as along a predetermined path, which may be linear or curved, in whole or in part. Rest surface 134 may uncouple from shoulder 154, stop surface 136 may uncouple from rotation stop boss 114, and end 156 of holder 104 may clear shoulder 154. Holder 104 may rotate (e.g., in the clockwise direction as shown in FIG. 8) about a pivot point, which is shown to be Axis A in the figures, for example, due to the location of the CG of holder 104 relative to Axis A. As shown in FIG. 8 for illustrative purposes, the CG is to the right of Axis A, thereby creating a clockwise torque (indicated by Arrow CW) causing holder 104 to rotate about Axis A in the clockwise direction. It will be understood that this movement, and the other movements described herein, may occur in other directions, such as the opposite or counterclockwise direction, and over any angular distance, as required by a particular application. In the position of FIG. 8, end 150 of biasing device 144 may at least temporarily confine shaft 106 to section 152A of slot 138, which may maintain the same, or approximately the same, pivot point location and may keep holder 104 from sliding relative to mount 102. For example, biasing device 144 may be configured to keep holder 104 from sliding along slot 138 far enough to disturb the preferred CG-to-pivot point relationship in the interim position shown in FIG. 8. Holder 104 may continue to rotate clockwise (as shown, for example), such as until the CG is directly under the pivot point (see FIG. 9), which is shown to be Axis A. Rest surface 134 may, but need not, contact over-travel stop boss 116, which may prevent excessive or undesired over-travel, for example, due to over-rotation caused by the momentum of holder 104. In at least one embodiment, over-travel stop boss 116 can be absent, as will be understood by one of ordinary skill having the benefits of the present disclosure. Holder 104 may, but need not, come to complete rest about shaft 106 at this point in the transition of support system 100 from Position 1 to Position 2, as illustrated in FIG. 9.

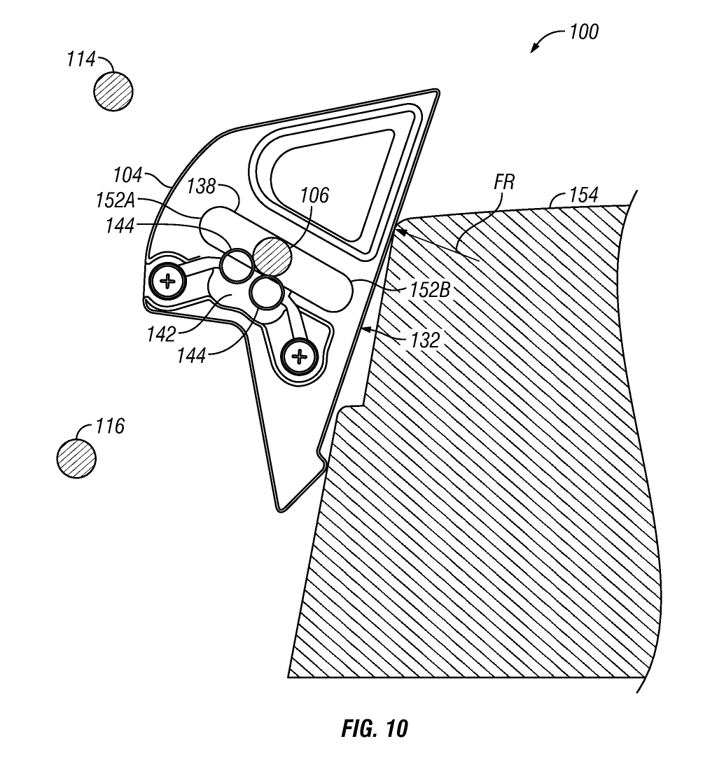

Referring now to FIG. 10, support system 100 may move toward shoulder 154 (in the downward direction as illustrated in the figures), which may result from one or more user actions or other inputs, but need not, and which may preferably occur naturally, such as due to gravity, in whole or in part. In an embodiment that includes movement by gravity, a need for user action or other input may be at least partially reduced, as may be desirable in one or more applications. Rubbing surface 132 may contact shoulder 154, which may cause a reactionary force FR normal to rubbing surface 132 from shoulder 154. Force FR may cause holder 104 to slide relative to shaft 106 along slot 138. Force FR may be sufficient to cause shaft 106 to flex or otherwise move biasing device 144 at least partially out of slot 138, such as into recess 142, for example, so that shaft 106 may be positioned out of section 152A and toward opposite end section 152B of slot 138 as holder 104 moves relative to shaft 106 (e.g., up and to the left as illustrated in FIG. 10). Holder 104 may continue to slide along slot 138 relative to shaft 106 (and mount 102, not shown), and rubbing surface 132 may contact shoulder 154, which may, but need not, include sliding relative thereto (e.g., down and to the left as illustrated in FIG. 10), until support system 100 moves into Position 2 as shown, for example, in FIG. 11. Once in Position 2, shaft 106 may be located in section 152B of slot 138, rubbing surface 132 may rest against shoulder 154, and support system 100 may at least temporarily rest, or be otherwise supported, in place. In at least one embodiment, which is but one of many, a portion of holder 104, for example, nose 160, may be suspended or free (e.g., FIG. 11A). However, it need not be, and nose 160 may alternatively contact a body, such as support surface 158 (e.g., FIG. 11B), which can include a component coupled to shoulder 154, or another surface, such as the ground or any surface supporting the system, in whole or in part, separately or in combination. The CG of holder 104 may be located horizontally from Axis A (e.g., to the left of Axis A as illustrated in FIG. 11), which may, for example, create a torque about Axis A in a direction opposite that shown in FIGS. 7-8 (e.g., in the counterclockwise direction as illustrated in FIG. 11, indicated by Arrow CCW). This torque may tend to cause holder 104 to rotate in the direction of Arrow CCW were holder 104 not supported by shoulder 154.

In Position 2, as illustrated, for example, in FIG. 11, an object may be supported in a second position and protruding end 150 of biasing device 144 may extend into a portion of slot 138 interior of shaft 106. From Position 2, support system 100 may be manipulated, such as by a second user action or input, which may, but need not, be the same or substantially the same as the first user action, to move through one or more interim positions to return to Position 1 (FIG. 7), wherein support system 100 may support an object in the first position described above. With reference to FIGS. 11 and 12, support system 100 may be moved in the upward direction, such as by being moved oppositely along the path described above, for example, so that rubbing surface 132 may uncouple from shoulder 154 and holder 104 may clear shoulder 154. Holder 104 may rotate about Axis A of shaft 106 (e.g., in the counterclockwise direction as illustrated in FIG. 12, indicated by Arrow CCW), for example, due to the position of the CG of holder 104 relative to its pivot point about Axis A. End 150 of biasing device 144 may keep shaft 106 at least temporarily positioned in section 152B of slot 138, which may prevent holder 104 from sliding relative to shaft 106 far enough to disturb a preferred relationship between CG and Axis A allowing holder 104 to rotate about shaft 106, such as in the direction of Arrow CCW, as may be required by a particular application. Stop surface 136 may contact rotation stop boss 114 (coupled to mount 102), for example, to prevent holder 104 from rotating too far (e.g., in the direction of Arrow CCW) as required by a particular application. Support system 100 may transition further toward Position 1, for example, by moving toward shoulder 154 (e.g., in the downward direction), and rest surface 134 may rest against shoulder 154, as illustrated in FIG. 13. Holder 104 may be restrained from rotating away from shoulder 154, for example, by contact between rotation stop boss 114 and stop surface 136. Downward Force F, such as due to the transfer of weight of mount 102 (not shown) and any object coupled thereto, may cause holder 104 to seat against rotation stop boss 114 and shoulder 154, and may cause holder 104 to slide along slot 138. For example, the position of shaft 106 may move from section 152B toward section 152A (e.g., down and to the left as shown in FIG. 13), which may include moving end 150 of biasing device 144 sufficiently out of slot 138 to allow shaft 106 to be positioned in section 152A of slot 138. Holder 104 may continue moving relative to shaft 106 until shaft 106 is positioned in section 152A, thereby returning support system 100 to Position 1, as shown in FIG. 7, which may include supporting an object in a first static position required by a particular application. It will be understood that while support system 100 has been described above as moving from Position 1 to Position 2 and back to Position 1, the steps may take place in reverse order (i.e., Position 2 to Position 1 and back to Position 2), or another order, as required by a particular application. It will also be understood that the geometry of support system 100, including, for example and without limitation, the shape of holder 104, the locations of stop bosses 114, 116 and shoulder 154, the positions of the CG, pivot point P, and Axis A, and other aspects of support system 100, may change as required from application to application. Based on the description above, such as with respect to FIGS. 7-13, it will be understood that support system 100 is useful for many applications. One or more of those applications will now be described.

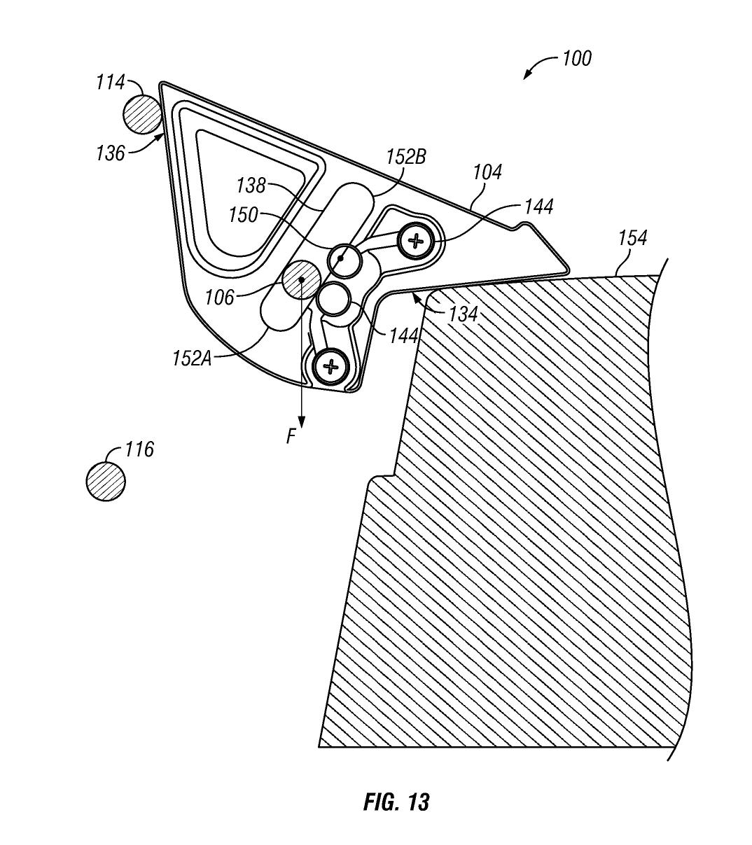

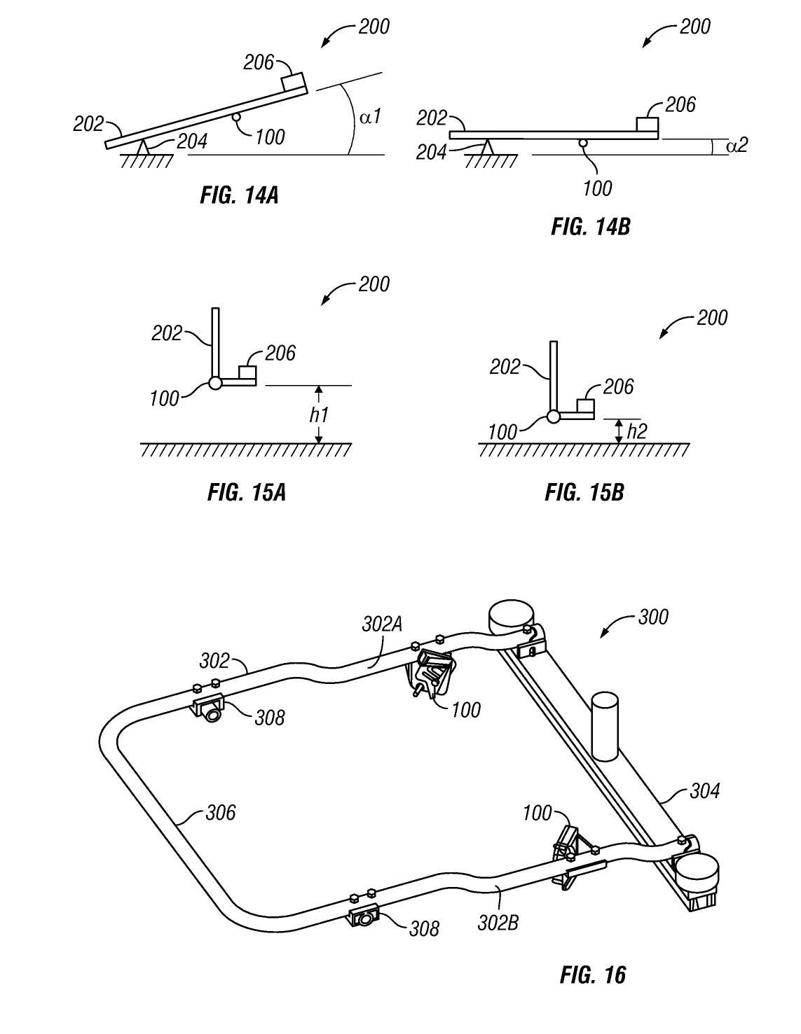

FIG. 14A is a schematic illustration of one of many embodiments of a support system 100 coupled with a support assembly 200 in a first position and utilizing certain aspects of the present invention. FIG. 14B is a schematic illustration of the embodiment of FIG. 14A in a second position. FIG. 15A is a schematic illustration of another of many embodiments of a support system 100 coupled with a support assembly 200 in a first position and utilizing certain aspects of the present invention. FIG. 15B is a schematic illustration of the embodiment of FIG. 15A in a second position. FIGS. 14A-15B will be described in conjunction with one another. With continuing reference to the description of FIGS. 7-13 above, FIGS. 14A-15B illustrate generally two of many examples of support system 100 supporting an object 206 in first and second positions, wherein one or more aspects of the present invention described above may be utilized to move object 206 from the first position to the second position. FIGS. 14A and 15A show support system 100 supporting an object 206 in the first position, and FIGS. 14B and 15B show support system 100 supporting an object 206 in the second position, which may be any positions, and in any order, required by a particular application. An actuator 202, such as a bar, tube, handle, step, or other structure, may be coupled to support system 100, for example, to first portion 108 of mount 102 (see, e.g., FIG. 1), for manipulating support system 100, as described with respect to FIGS. 7-13. Actuator 202 may, but need not, be purely mechanical, and may alternatively be electro-mechanical, such as including a linear actuator, for example, to manipulate support system 100 at the touch of a button. A user may move support system 100 along a predetermined path a first time to move object 206, for example, from the first position (FIGS. 14A, 15A) to the second position (FIGS. 14B, 15B), and then a second time along the path to move object 206 back to the first position. As shown for illustrative purposes in FIGS. 14A-14B, for example, actuator 202 may rotate about a pivot 204, which may move support system 100 along a curved path. In such an embodiment, which is but one of many, the difference between the first position and the second position of object 206 may be expressed, for example, by two angles, “α1” and “α2”, which may, but need not, have different values. As another example, as shown in FIGS. 15A-15B, actuator 202 may move support system 100 along a linear path, which may, but need not, be vertical, and may alternatively be angled. In such an embodiment, which is but one of many, the difference between the first position and the second position of object 206 may be expressed, for example, by two heights, “h1” and “h2”, which may, but need not, have different values.

Turning now to further aspects of the present invention, one or more of many applications of the present invention will now be described. FIG. 16 is an isometric view of one of many embodiments of a support system 100 coupled to a tool assembly 300 and utilizing certain aspects of the present invention. As an example of one of many embodiments of the present invention, support system 100 may be configured to be coupled to an assembly, such as, for example, a tool assembly 300. Tool assembly 300 may include a frame 302 having one or more (e.g., two as shown in FIG. 16) systems 100 coupled thereto for supporting assembly 300, such as for moving frame 302 between first and second positions, as required by a particular application. Tool assembly 300 may include a tool 304, such as a vacuum tool, for example, a squeegee, brush, blade, bucket, scoop, or other tool, separately or in combination, but need not, and may alternatively include any object or structure required by a particular application. Tool assembly 300 may include an actuating end 306 for communicating with support system 100 and tool 304, which may be actuated by any user action or other input required by a particular application, for example and without limitation, pushing, pulling, stepping on, lifting, lowering, or another action, or alternatively an inaction, separately or in combination. As shown in the embodiment of FIG. 16, which is but one of many, frame 302 may have one or more pivots 308 coupled thereto, and a user may, for example, move frame 302 about the one or more pivots 308 to manipulate support system 100. It will be understood that frame 302 need not have pivots, and may alternatively include hinges, bolts, or other structure. It will also be understood that while frame 302 is shown to include two longitudinal members 302A, 302B, one or more other embodiments need not include these components, and may alternatively include a single member, a single support system 100, or a single pivot 308, or another number of each component, which may be any number required by a particular application, separately or in combination.

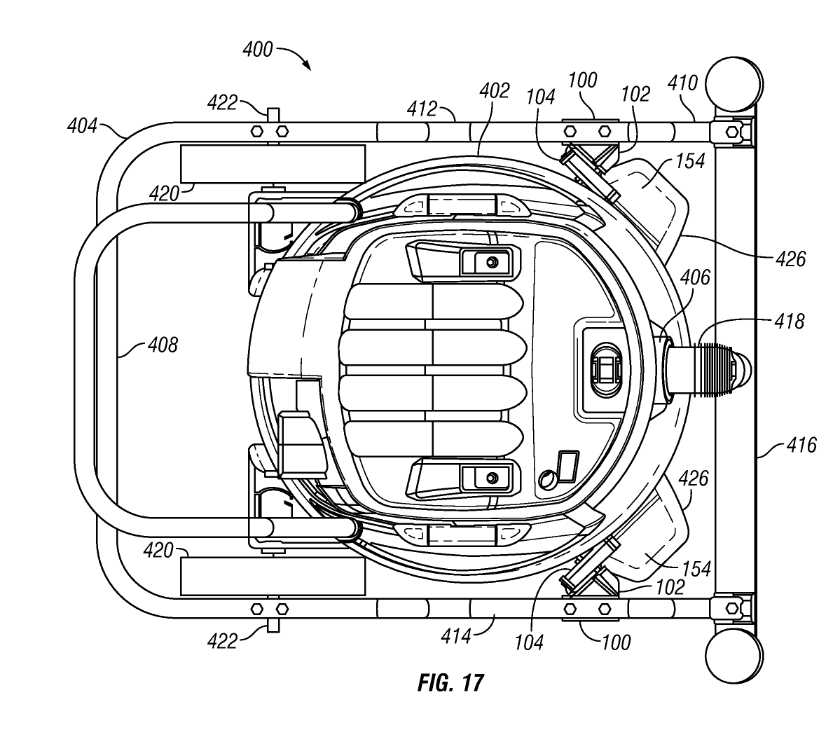

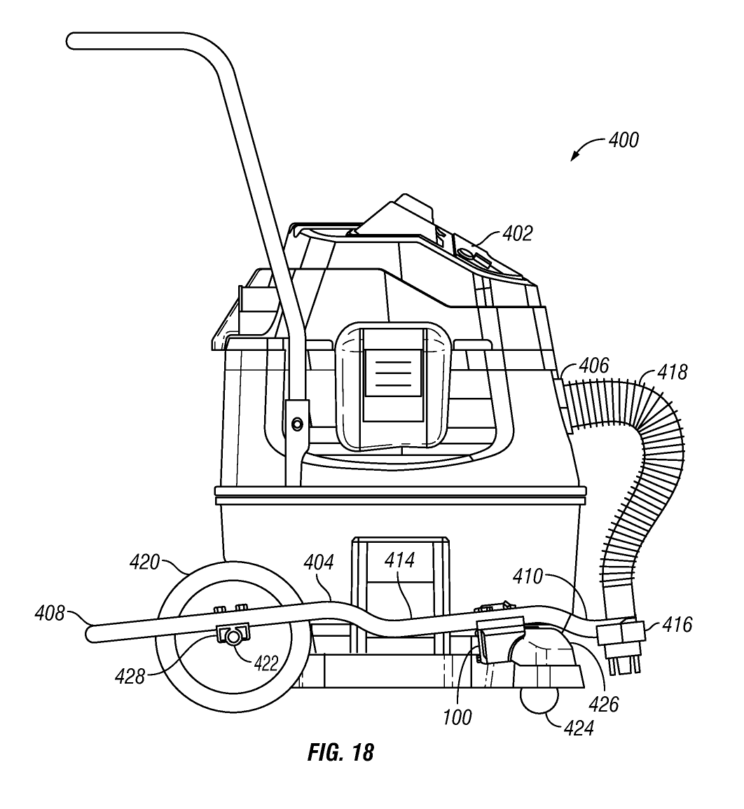

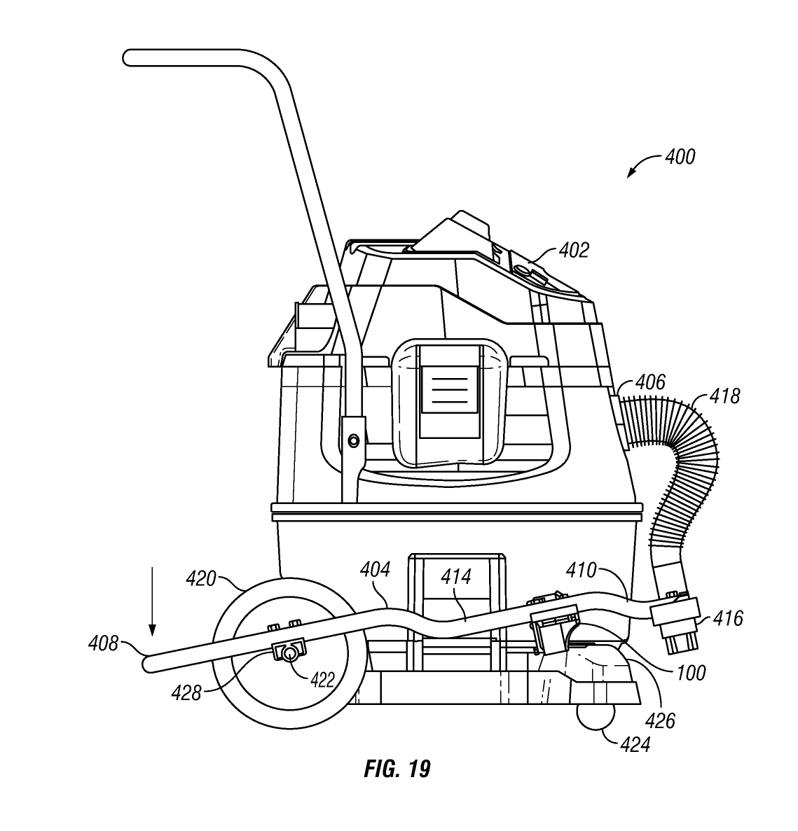

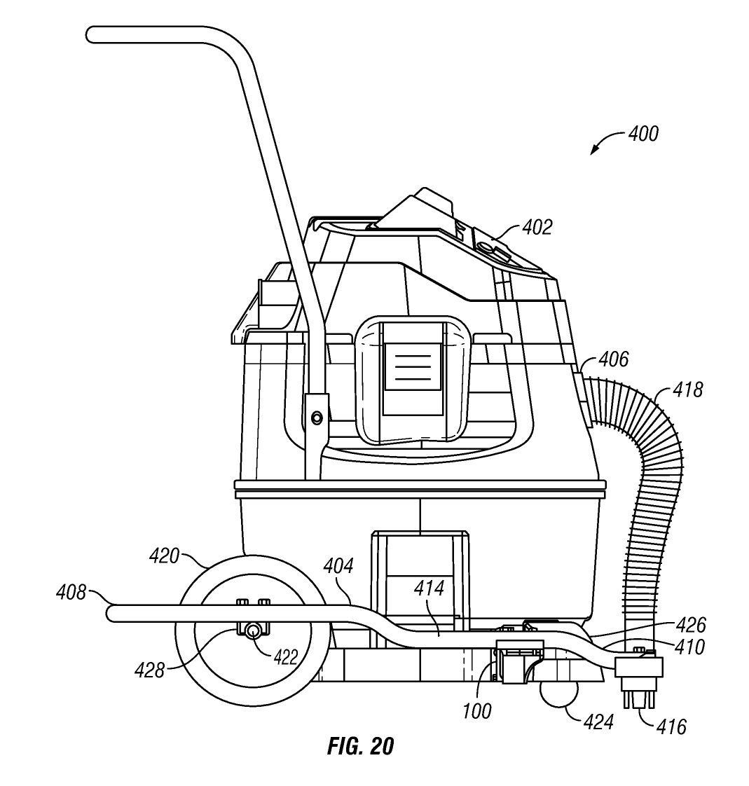

FIG. 17 is a top view of one of many embodiments of a support system 100 coupled to a vacuum cleaner system 400 and utilizing certain aspects of the present invention. FIG. 18 is a side view of the support system 100 of FIG. 17 in a first position. FIG. 19 is a side view of the support system 100 of FIG. 17 in an interim position. FIG. 20 is a side view of the support system 100 of FIG. 17 in a second position. FIGS. 17-20 will be described in conjunction with one another. As another example of one of many embodiments of the present invention, support system 100 may be adapted to couple to a vacuum cleaner system 400, for example, for supporting one or more components of the vacuum cleaner system. As illustrated in FIGS. 17-20 for illustrative purposes, vacuum cleaner system 400 may include a vacuum cleaner 402 and a tool assembly 404. Vacuum cleaner 402 may be any vacuum cleaner, such as a conventional wet/dry vacuum cleaner, which may generally include a vacuum motor, collector, motor cover, electric cord, controls, and other vacuum components, as will be understood by one of ordinary skill and which need not be further described herein. Tool assembly 404 may be similar to or the same as that described above with respect to FIG. 16, but need not, and may alternatively be configured in any manner required by a particular application, as will be understood by one of ordinary skill having the benefits of this disclosure. Support system 100 may be similar to or the same as one or more of the embodiments described above, but need not be, and while like reference numerals and position numbers are used herein for point of clarity, one of ordinary skill will readily understand that they do not imply exact likeness between embodiments and that each component may be formed, configured and adapted in any manner required by a particular application. For example, positions and sizes of components, relative positions of components, predetermined paths, and ranges of motion, among other things, may differ from application to application without departing from the spirit of the invention as described herein using illustrative and exemplary embodiments and figures.

With reference to FIG. 17, vacuum cleaner system 400 may include a vacuum cleaner 402, which may include an air inlet 406 for receiving vacuumed air and debris. Vacuum cleaner system 400 may include a tool assembly 404 coupled to vacuum cleaner 402 for supporting one or more components of the vacuum cleaner system. Tool assembly 404 may include a first end, such as actuating end 408, a longitudinally opposite end, such as support end 410, and one or more structural members 412, 414 coupled there between. Tool assembly 404 may include structure for coupling the assembly to vacuum cleaner 402, such as, for example, one or more pivots 428 (see, e.g., FIG. 18). Tool assembly 404 may be of single piece construction, such as a molded or otherwise formed frame, or one or more components may be formed separately and coupled together. Support end 410 may be adapted to couple with or support structure for vacuuming, which may include any object required by a particular application, such as tool 416 or other structure. In the embodiment shown in FIGS. 17-20, tool 416 is shown to be a squeegee for illustrative purposes, but need not be, and may alternatively include, without limitation, a brush, blade, scoop or other device, separately or in combination. As another example, tool 416 may include a bumper, stop, or brake, such as for holding vacuum cleaner system 400 in place, temporarily or otherwise. Vacuum cleaner system 400 may include a conduit 418, such as a hose, pipe or tube, for example, for carrying vacuumed air and debris from tool 416 to inlet 406 during vacuuming. Vacuum cleaner system 400 may include one or more support systems 100 for supporting tool assembly 404, such as by holding one or more components. As shown in FIG. 17, at least one embodiment of vacuum cleaner system 400, which is but one of many, may preferably include two support systems 100, wherein each support system 100 may have a mount 102 and a holder 104 coupled to tool assembly 404. Vacuum cleaner system 400 may, but need not, include wheels for moving the system during use. For example, vacuum cleaner system 400 may include a pair of wheels 420 coupled to one or more axles 422 and a pair of casters 424 (see, e.g., FIG. 18) coupled to vacuum cleaner 402, which may, but need not, be coupled to caster feet 426. In an embodiment of vacuum cleaner system 400 having caster feet 426, which is but one of many, caster feet 426 may include a shoulder 154 for communicating with one or more surfaces of holder 104, as described previously herein, but this need not be the case, and shoulder 154 may alternatively be separate from a caster foot 426 (if present), such as being a separate component formed on or otherwise coupled to vacuum cleaner 402. Tool assembly 404 may be coupled to vacuum cleaner 402 in any manner required by a particular application, which may include the use of couplers, such as screws, bolts, pins or other fasteners. For example, as shown in FIGS. 17-20 for illustrative purposes, pivots 428 may be coupled to axle 422, directly or indirectly, such as to allow tool assembly 404 to pivot about axle 422 during operation of support system 100, as will be further described below. However, this need not be the case, and tool assembly 404 may alternatively be coupled to another component of vacuum cleaner system 400, such as to a handle, body, drum or other portion. As another example, and as described above, tool assembly 404 need not pivot at all, but may alternatively move in any manner sufficient to operate support system 100 as required by a particular application.

Turning now to FIG. 18, tool assembly 404 is shown in a first position, which is shown herein as an “up” position for purposes of reference and explanation, wherein tool 416 may be positioned above a surface to be vacuumed and wherein support system 100 may be in a first position, such as, but not limited to, Position 1 described above (see FIG. 7). To move tool assembly 404 from the first position to a second position, a user may manipulate actuating end 408 using a first action, for example, by stepping or pressing downwardly thereon (as indicated by the arrow in FIG. 19), which may at least temporarily move tool assembly 404 to one or more interim positions, such as the position shown in FIG. 19 for illustrative purposes. For example, tool assembly 404 may pivot about axle 422 (e.g., counterclockwise as illustrated in FIG. 19) and support system 100 may move at least partially along a path (e.g., upward as shown in FIG. 19), which may allow holder 104 to transition toward a second position, such as, but not limited to, Position 2 described above (see FIG. 11). Tool 416 may, but need not, ascend further above the surface, such as shown in FIG. 19. A user may continue the first action on actuating end 408, such as by reducing or eliminating any forces the user applied. Tool assembly 404 may pivot in an opposite direction (e.g., clockwise as illustrated in FIG. 19) until the second position is reached, which may include holder 104 being in a second position and tool 416 being in contact with the surface, as shown in FIG. 20. After vacuuming, for example, a user may manipulate actuating end 408 using a second action, which may, but need not, be the same or substantially the same as the first action. In response, tool assembly 404 may move from the second position (FIG. 20) to the first position (FIG. 18), such as by reversing one or more of the steps just described.

It will be understood that positional terms such as “first,” “second,” “up,” “down,” and like terms have been used arbitrarily herein and for purposes of illustration. The positions described and shown herein may include any position required by a particular application, and may be held in any order and in any number. As will also be understood by one of ordinary skill having the benefits of the present disclosure, phrases such as “the same,” “substantially the same,” and like terms or phrases are used broadly herein, and may, but need not include identicalness, and specifically include, without limitation, user actions that are about the same, such as applying a force to or releasing a force from one or more components, whether or not the action occurs exactly in the same location on the component, in the same manner, to the same extent or magnitude, as a result of exactly the same input, or produces exactly the same result. As one example, which is but one of many, a user may step on one portion of an actuator to activate a tool assembly, and may later again step on the actuator to deactivate the tool assembly; although the two steps may be performed in a different location, with a different amount of force, or even with a different foot or appendage, the two actions are “the same” for purposes of the present disclosure.

Other and further embodiments utilizing one or more aspects of the invention described above can be devised without departing from the spirit of Applicant's invention. For example, one or more support systems having any required capacity may be coupled with any device or machine, such as lifts, lawn mowers, tractors, heavy machinery, vacuum cleaners without wheels, vehicles, and other assemblies. Further, the various methods and embodiments of the support system can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, the Applicant intends to fully protect all such modifications and improvements that come within the scope or range of equivalents of the following claims.

What is claimed is:

1. A support system, comprising:
a holder having a first face, a second face, at least one peripheral surface, and a slot extending from the first face at least partially through the holder toward the second face;
a mount having an outer surface and at least one stop boss extending outwardly from the outer surface and adapted to communicate with the at least one peripheral surface of the holder; and
a shaft having a first end coupled to the mount and a shaft body extending outwardly from the outer surface of the mount;
wherein the shaft body is slideably disposed in the slot, thereby coupling the holder to the mount so that the holder can rotate and slide relative to the mount about the shaft.

2. The support system of claim 1, further comprising a shoulder disposed adjacent to the holder and configured to communicate with the at least one peripheral surface.

3. The support system of claim 1, wherein the mount is moveable along a predetermined path, the path having a start point and an end point.

4. The support system of claim 3, wherein the holder is configured to independently rotate about the shaft when the mount is disposed at one or more interim points between the start point and the end point of the path.

5. The support system of claim 4, wherein the holder is configured to rotate in a first direction when the mount is moved from the start point to the end point of the path.

6. The support system of claim 5, wherein the holder is configured to rotate in a second direction when the mount is moved from the end point to the start point of the path.

7. The support system of claim 3, further comprising an actuator coupled to the mount and configured to selectively move the mount along the predetermined path.

8. The support system of claim 3, wherein the holder mount is configured to be moved from the start point to the end point by a first user action, and from the end point to the start point by a second user action.

9. The support system of claim 8, wherein the first user action and the second user action are at least substantially the same.

10. The support system of claim 1, further comprising:
a biasing device coupled to the holder;
wherein the biasing device is configured to at least temporarily impede sliding movement of the holder relative to the mount.

11. The support system of claim 10, wherein the biasing device is a spring having a spring force, and wherein at least a portion of the spring is disposed in the slot and configured to contact the shaft, the spring force being sufficient to confine the shaft to a predetermined section of the slot until the spring force is overcome.

12. The support system of claim 1, wherein the holder mount further comprises structure for coupling with an object to be supported.

13. A method of moving an object between a first position and a second position, the object being coupled to a support system having a mount configured to move along a predetermined path and a holder slideably and rotatably coupled to the mount, the method comprising:
supporting the object in the first position by disposing the mount at a start point of the path so that a center of gravity of the holder is disposed at a first location relative to a pivot;
moving the mount along the path toward an end point of the path, thereby allowing the holder to rotate about the pivot in a first direction;
disposing the mount at the end point of the path; and
supporting the object in the second position.

14. The method of claim 13, further comprising disposing the mount so that the center of gravity of the holder is disposed at a second location relative to the pivot when the object is in the second position.

15. The method of claim 13, further comprising contacting a surface with the holder after the holder at least partially rotates in the first direction, thereby defining an angular distance over which the holder can rotate in the first direction.

16. The method of claim 13, wherein supporting the object in the first position includes carrying a weight of the object with the holder, and wherein supporting the object in the second position comprises disposing the object and the holder so that at least a portion of the weight of the object is no longer carried by the holder.

17. The method of claim 13, further comprising slideably moving the holder relative to the mount.

18. The method of claim 13, further comprising:
moving the mount along the path back toward the start point of the path, thereby allowing the holder to rotate about the pivot in a second direction opposite the first direction; and
disposing the mount at the start point of the path so that the center of gravity of the holder is disposed at the first location relative to the pivot, thereby supporting the object in the first position.

19. The method of claim 18, further comprising contacting a surface with the holder after the holder at least partially rotates in the second direction, thereby defining an angular distance over which the holder can rotate in the second direction.

20. The method of claim 18, further comprising slideably moving the holder relative to the mount.

21. A tool assembly for a vacuum cleaner, comprising:
a frame configured to be moveably coupled to the vacuum cleaner, the frame having a first end and a longitudinally opposite second end;
a tool coupled to the second end; and
at least one support system as claimed in claim 1 coupled to the frame between the first end and the second end.

22. The tool assembly of claim 21, further comprising a pivot coupled to the frame between the first end and the at least one support system.

23. The tool assembly of claim 22, wherein the first end of the frame is configured to be manipulated by a user to rotate the frame about the pivot.

24. The tool assembly of claim 22, wherein the pivot is configured to be coupled to an axle of the vacuum cleaner.

25. The tool assembly of claim 21, wherein the tool is selected from the group consisting of a squeegee, a brush, a blade, and any combination thereof.

26. The tool assembly of claim 21, further comprising a shoulder configured to be coupled to the vacuum cleaner adjacent to the holder so that the at least one peripheral surface can communicate with the shoulder.

27. A vacuum cleaner system, comprising:
a vacuum body having a debris collector, an air inlet, and an air outlet;
an electric vacuum motor coupled to the air outlet;
a tool assembly as claimed in claim 21 coupled to the vacuum body; and
a conduit having a first end coupled to the tool and a second end coupled to the air inlet, the conduit being adapted to carry air and debris to the debris collector during vacuuming.

28. The vacuum cleaner system of claim 27, further comprising a shoulder coupled to the vacuum body adjacent to the holder and configured to communicate with the at least one peripheral surface.

29. The vacuum cleaner system of claim 28, wherein the shoulder is at least a portion of a caster foot.

30. The vacuum cleaner system of claim 27, further comprising:
a pivot coupled to the frame between the first end and the at least one support system; and
wherein the tool assembly is pivotally coupled to the vacuum cleaner body about the pivot.

31. The vacuum cleaner system of claim 30, wherein the first end of the frame is configured to be manipulated by a user to rotate the frame about the pivot.

32. The vacuum cleaner system of claim 30, wherein the pivot is configured to be coupled to an axle of the vacuum cleaner.

33. The vacuum cleaner system of claim 27, wherein the tool is selected from the group consisting of a squeegee, a brush, a blade, and any combination thereof.
